(19) United States
(12) Patent Application Publication
(10) Pub. No.: US 2005/0149868 A1
(43) Pub. Date: Jul. 7, 2005

(54) User interface application development program and development apparatus

(75) Inventors: Asako Katayama, Kawasaki (JP); Takahide Matsutsuka, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED, Kawasaki (JP)

(21) Appl. No.: 10/851,570

(22) Filed: May 21, 2004

(30) Foreign Application Priority Data
Dec. 26, 2003 (JP) 2003-435608

(51) Int. Cl. G06F 3/00

(52) U.S. Cl. 715/700

(57) ABSTRACT

A user interface application development program comprises a step of reading a specification data for application development, which can make an association between a screen and/or a process and an object, and a step of automatically interpreting the specification data including the association made between the screen and/or the process and the object, and of generating a user interface application program.

### BACKGROUND OF THE INVENTION

1. Field of the Invention

The present invention relates to a program development method, and more particularly, to a user interface application development program and development apparatus that enable the completely automatic generation of an application program having a user interface, and can enhance the development efficiency and the maintainability of the program.

2. Description of the Related Art

In recent years, a method using object-oriented technology has been extensively used as a method designing software. Special attention is focused on a Web application development method that combines a language called a UML (Unified Modeling Language) not dependent on a platform, and an object-oriented language such as Java (registered trademark).

As such a software development method, a method that enables a program or its components to be generated as automatically as possible is desired. For such automatic generation of a program, the following conventional techniques exist.
[Patent Document 1] Japanese Patent Publication No. HEI6-230949 “Program Automatic Generation Apparatus”
[Patent Document 2] Japanese Patent Publication No. HEI 11-237982 “Software Component Development Assisting Apparatus”
[Patent Document 3] Japanese Patent Publication No. 2000-339149 “State Transition Model Creation Method and Apparatus”
[Patent Document 4] Japanese Patent Publication No. 2000-116911 “Object-oriented Program Automatic Generation Apparatus”

Patent Document 1 discloses a program automatic generation apparatus that can reuse the specification of an unchanged unit when units configuring a system to be controlled are changed, can increase the efficiency of producing software, and can make a compact and plain description of a specification even if the number of units becomes large.

Patent Document 2 discloses a technique for assisting in the development of a reusable component by using information about an unchanged/changed portion of a specification, which is obtained by analyzing required specifications common to an application of a problematic region, in order to develop a reusable component in object-oriented software.

Patent Document 3 discloses a technique for shortening a time required to extract a state, an input event, an action, and an output event in the creation of a state transition model.

Patent Document 4 discloses a program automatic generation apparatus that can increase the operation efficiency of software development by making the automatic generation of program code of a dynamic portion along with the automatic generation of program code of a static portion in the development of an object-oriented program.

However, according to Patent Document 1, a relationship among units must be described in a state transition model. For example, a relationship between a screen and a display data item, and a screen layout on a client side in a user interface application must be described in a state transition model, so that a lot of trouble is taken for the development.

According to Patent Document 2, an analysis model of required specification is converted into design information, and an object-oriented software component is developed. However, it is difficult to automatically convert the software component into, for example, a Web application program by the definition of a design model.

According to Patent Document 3, a message sequence chart must be described in addition to a state transition table, and a lot of trouble is taken until a program is automatically generated.

According to Patent Document 4, after the definition of a dynamic portion is extracted and a state machine tree is built, a program code must be generated by integrating the dynamic portion with a static portion. Therefore, a lot of trouble is taken until a final program product is developed.

In the automatic development of an object-oriented program, UML as a language that is not dependent on a platform exists as described above. Unlike a general program language that stipulates a grammar and syntax, creates a program according to the grammar and the syntax, and compiles the created program, the UML is characterized in that modeling using elements such as object-oriented class, object, etc. is performed by representing a diagram such as an activity diagram, etc.

However, the UML does not originally have a representation method that can represent all of characteristics of a screen transition, and has difficulties in the design representation of a screen transition portion. As a result, a totally different representation method must be introduced only for the screen transition portion, and a developer experiences a lot of trouble to learn both of the representation methods. The following document exists as a conventional technique for solving such a problem.
[Non-patent Document 1] http://www-6.ibm.com/jp/software/websphere/develope r/wsad/workshop/v5/index.html “Struts Application Development (later edition)”

This document discloses an apparatus automatically generating a user interface from a screen transition diagram. With this technique, an object used in a screen transition can be represented by using a representation method different from the UML. However, the complete generation of an application including process logic cannot be made, and a user must generate a program of a portion not generated while reading a source generated halfway with this technique.

Specifically, with this technique, first, a screen, and a target object of data input/output used in a process cannot be clarified for screen transition logic, and the flow of program control or the flow of data. Second, there is no method of specifying the name of a screen layout, or the name of a button which appears on a screen. Third, there is no method of accurately representing the order of passing objects among screen process modules.

### SUMMARY OF THE INVENTION

An object of the present invention is to enable the completely automatic generation of an object-oriented program by allowing the representation of a specification data for application development, which can make an association, for example, between a screen and/or a process and an object as input/output data for the automatic generation of a program, for example, by using the UML, in view of the above described problems.

A user interface application development program according to the present invention causes a computer to execute a process for automatically generating a user interface application program, the process comprising: reading a specification data for application development, which corresponds to a screen transition diagram where a screen and a process are described, and can make an association between a screen and/or a process and an object as input/output data; and automatically interpreting the read specification data including the association made between the screen and/or the process and the object, and generating the user interface application program.

A user interface application development apparatus according to the present invention comprises: a specification data reading unit reading a specification data for application development, which corresponds to a screen transition diagram where a screen and a process are described, and can make an association between a screen and/or a process and an object as input/output data; and a program generating unit automatically interpreting the read specification data including the association made between the screen and/or the process and the object, and generating a user interface application program.

According to the present invention, a specification that is difficult to be represented, for example, with a conventional UML representation method, such as a data input/output relationship between an activity which describes a screen or a process and an object, input/output specifications of a call activity which calls an external program, etc., control corresponding to an initial state or a final state, etc., can be newly designated, whereby the completely automatic generation of an application program having a user interface can be made. This greatly contributes to improvements in the development and maintainability of the program.

### DESCRIPTION OF THE DRAWINGS

FIG. 1 is a block diagram showing the principle of functions of a user interface application development program according to the present invention;

FIG. 2 explains the whole of a development method of a user interface application program in a preferred embodiment;

FIG. 3 explains the whole of a method from the definition of a specification until its execution in the preferred embodiment;

FIG. 4 explains an application region that is not dependent on a platform in the preferred embodiment;

FIG. 5 explains a definition entity corresponding to a specification data in the preferred embodiment;

FIG. 6 exemplifies a call activity in a logic flow;

FIG. 7 is a flowchart showing the whole of a process from the reading of a definition entity until the output of a program file;

FIG. 8 is a flowchart showing the whole of a process from the reading of a specification data until the generation of a program in the preferred embodiment;

FIG. 9 explains a representation method of an association made between an activity and data input/output objects;

FIG. 10 explains a representation method of an association made between a screen activity and a screen display layout;

FIG. 11 explains a representation method of an order of data inputs from objects to an activity;

FIG. 12 explains a representation method of a return value from a final state;

FIG. 13 explains a representation method of an expression which specifies an operation corresponding to a final state;

FIG. 14 explains a representation method of a return value from a final state of an exception;

FIG. 15 explains a representation method of return values from a plurality of final states;

FIG. 16 explains a representation method of a data input/output relationship between an initial state and an object;

FIG. 17 explains a representation method of the same instance in different screen transition diagrams;

FIG. 18 explains a representation method of different instances of the same object in one screen transition diagram;

FIG. 19 explains a representation method of an input of a branch condition parameter from an object for a branch process; and

FIG. 20 explains a representation method of a specification for distributed object component call.

### DESCRIPTION OF THE PREFERRED EMBODIMENTS

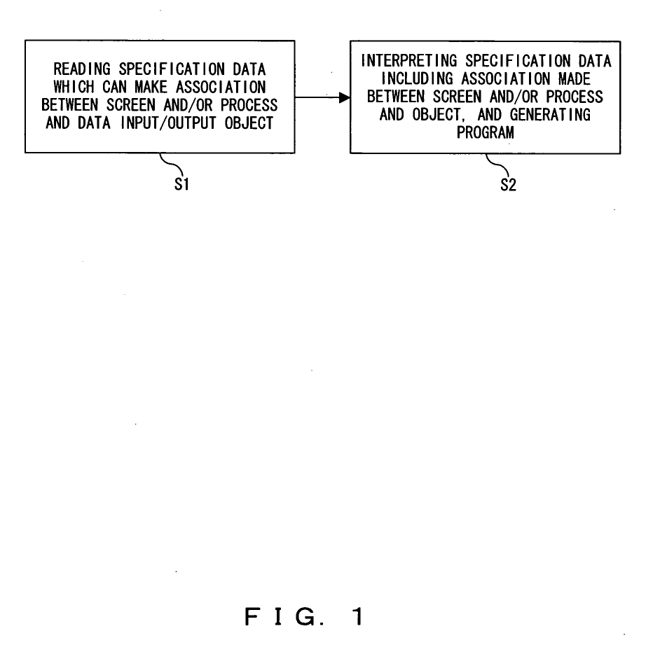

FIG. 1 is a block diagram showing the principle of functions of a user interface application development program according to the present invention. This figure is a block diagram showing the principle of the functions of the program for automatically generating a user interface application program. With this program, a specification data is read in step S1, and a program is generated in step S2.

In step S1, the specification data for application development, which corresponds to a screen transition diagram where a screen and a process are described, and can make an association between a screen and/or a process and an object as input/output data, is read. In step S2, the read specification data is automatically interpreted including the above described association made between the screen and/or the process and the object, and a user interface application program is generated.

In a preferred embodiment according to the present invention, the above described object is an object which corresponds to a process for a screen display, and the above described specification data can also indicate a screen layout in addition to the association made between the process and the data input/output object for a screen to be displayed. Or, the object corresponds to a process which is associated with a screen transition process and intended to read an external process, and the above described association made by the specification data can also indicate the order of each plurality of input objects or output objects for an associated process.

In a preferred embodiment, the above described specification data can further designate the next state transition condition, for example, the name of a button which is to be clicked on a screen.

Additionally, in a preferred embodiment, the specification data, can further define an identifier of a final state, state types including, for example, a name or an exception, an expression describing an action after an end, one or more return values to a call source of a screen transition diagram, an input/output object corresponding to the final state, and the order of inputs/outputs, respectively in correspondence with one or more final states in a screen transition diagram, and can also control the final state including a call relationship among a plurality of screen transition diagrams. Or, corresponding to an initial state on a screen transition diagram, the specification data can further define a data input/output object and the order of inputs/outputs in correspondence with the initial state, and can also control the initial state including a call relationship among a plurality of screen transition diagrams.

In a preferred embodiment, the specification data can further determine whether or not a plurality of instances each having an object of the same name are identical in a plurality of screen transition diagrams by designating the scopes of the instances, can further designate, in correspondence with a branch process in a screen transition diagram, a parameter input object which indicates a condition of the branch, and can further include data which enables a call of a distributed object component based on the protocol of the distributed object component.

A user interface application development apparatus according to the present invention comprises a specifications data reading unit, and a program generating unit. The specifications data reading unit is intended to read a specification data for application development, which corresponds to a screen transition diagram where a screen and a process are described, and can make an association between a screen and/or a process and an object as input/output data. The program generating unit is intended to automatically interpret the read specification data including the association made between the screen and/or the process and the object, and to generate a user interface application program.

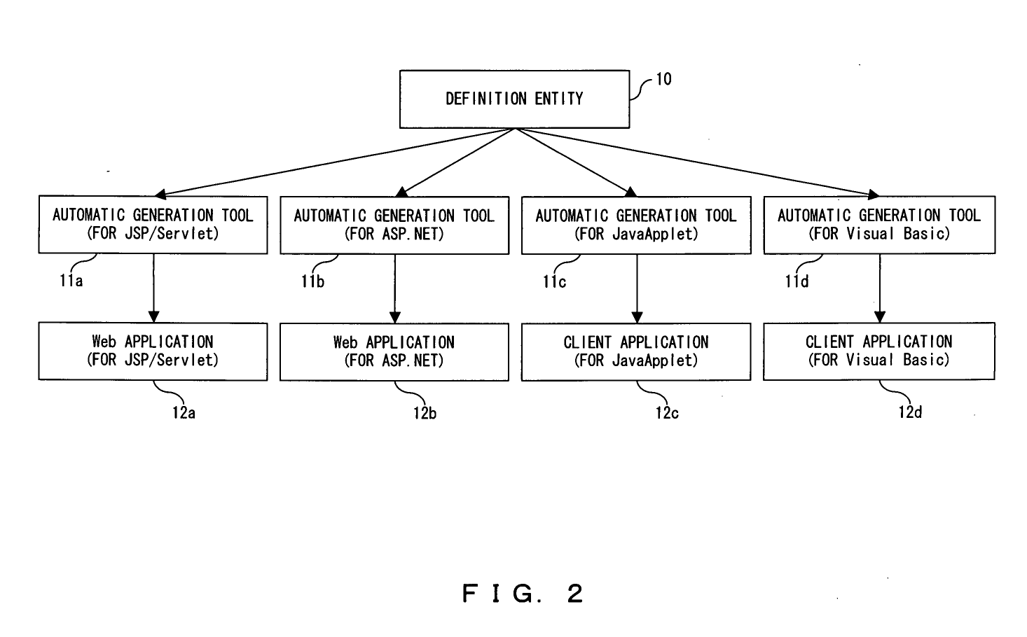

FIG. 2 explains the whole of a user interface application automatic development method according to the present invention. In a preferred embodiment according to the present invention, a definition entity 10 which is not dependent on a platform and written, for example, in a UML is first created, and an automatic generation tool dependent on the platform is used for the definition entity 10, whereby a Web application or a client application is created as a user interface application.

In FIG. 2, a Web application 12a for Java Server Pages (JSP)/Servlet is created, for example, by using an automatic generation tool 11a for JSP/Servlet. Similarly, a Web application 12b is created by using an automatic generation tool 11b for Active Server Pages (ASP).NET as one of mechanisms for generating a page on a Web server.

Additionally, a client application 12c for Java (registered trademark) Applet is created by using an automatic generation tool 11c for Java Applet, which is Java client software downloaded and executed in a browser.

Furthermore, a client application 12d for Visual Basic is created by using an automatic generation tool lid for Visual Basic as a programming language, which is based on Basic for simply creating a graphic user interface.

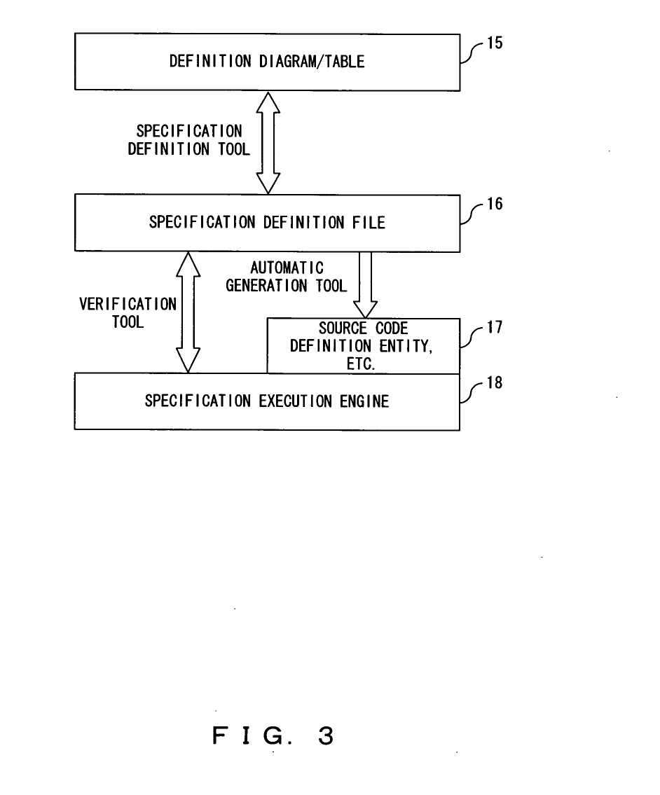

FIG. 3 explains the whole of a user interface application development method, which uses the various types of automatic tools, from the generation of a definition file for a user interface application up to the execution and verification of an application program in this preferred embodiment. In this figure, as described above, a definition diagram/table 15 is described, for example, in a UML, and a specification definition file 16 is created by a specification definition tool in correspondence with the description.

By using the specification definition file 16, a source code or a definition entity 17, which corresponds to a program, is automatically generated by the automatic generation tools, and its specification, namely, the program is executed by a specification execution engine 18 with the use of the result of the generation. The result of the execution of the specification is verified by a verification tool, and debug information is generated. Then, the debug information is given to the specification definition file, for example, as an event notification, and the specification definition file is modified depending on need.

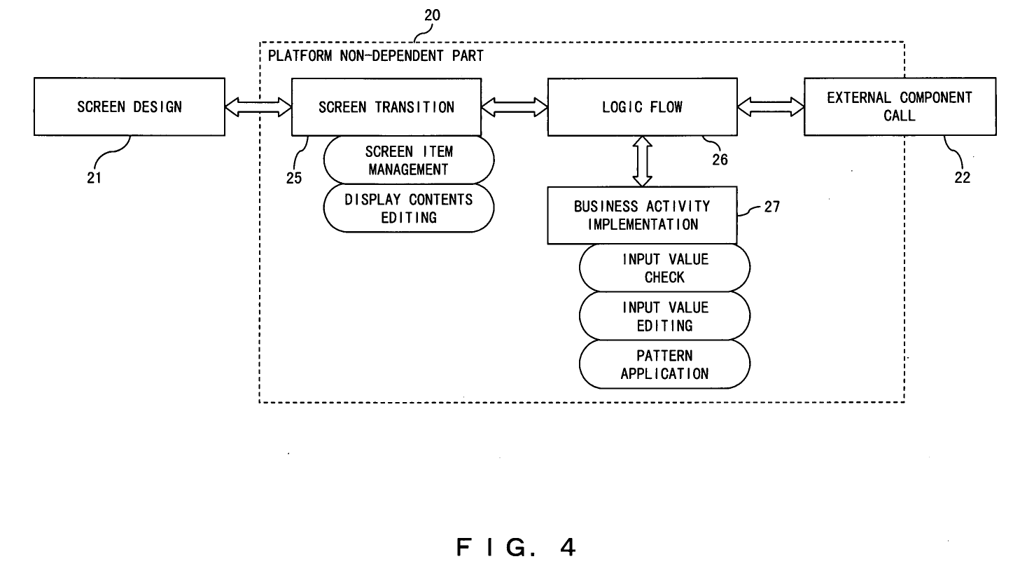

FIG. 4 explains an application region resolved in this preferred embodiment. As described above, the application region in this preferred embodiment is configured mainly by a platform non-dependent part 20. The application region naturally includes a screen design 21 dependent on a platform, and an external component call 22.

The platform non-dependent part 20 includes a screen transition 25 and a logic flow 26, which are the main entities of user interface application development in this preferred embodiment, and business activity (business logic) implementation 27 corresponding to the logic flow 26 as main constituent elements. For the screen transition 25, the management of screen items, and the editing of display contents are required. For the business activity implementation 27, an input value check, input value editing, and pattern application are required.

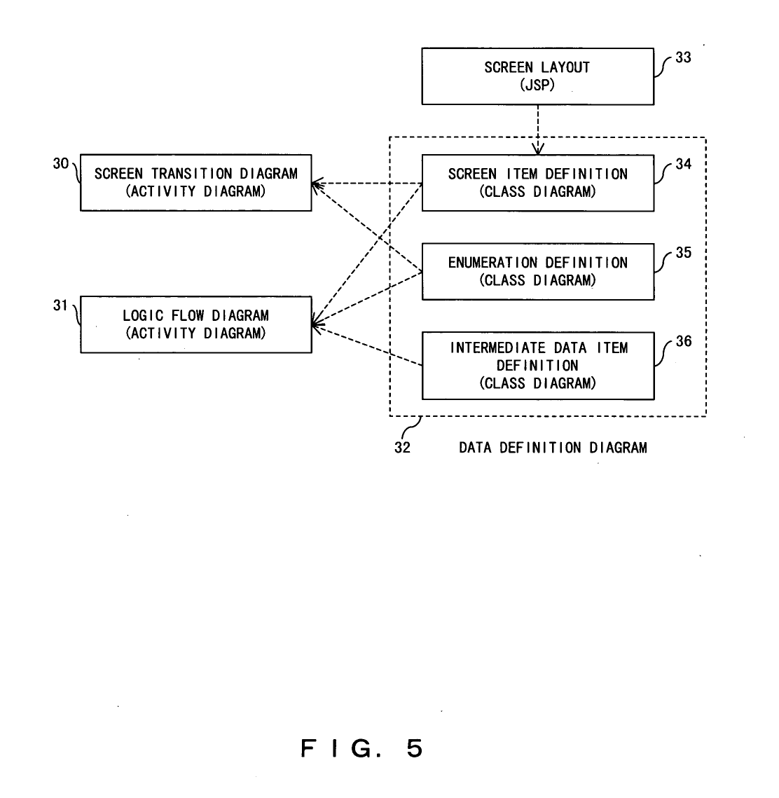

FIG. 5 shows the entire structure of a definition entity created in this preferred embodiment. In this figure, the definition entity is fundamentally configured by a screen transition diagram 30, a logic flow diagram 31, a data definition diagram 32, and a screen layout 33 in correspondence with the application region shown in FIG. 4.

The screen transition diagram 30, where a screen and logic (a process) are described depending on need, for example, described alternately, is intended to represent a transition between a screen and logic, and an item or a layout associated with each screen. The screen transition diagram 30 is, for example, a UML activity diagram. The logic flow diagram 31 is intended to describe the details of the logic within the screen transition diagram. The logic flow diagram 31 is, for example, also a UML activity diagram.

The screen layout 33 is intended to describe the layout information of a screen. In an implementation of a Web application, the screen layout 33 is represented by a JSP page. The data definition diagram 32 is represented by a class diagram which does not include an activity diagram, The data definition diagram 32 is used for item definitions such as a screen item definition 34, an enumeration definition 35, an intermediate data item definition 36, etc.

The screen item definition 34 is intended to define an item for a screen display. The item includes a name and a type. Examples of the type include a character string, an integer, a real number, a compound type, etc. The enumeration definition 35 is intended to define an enumeration item. The intermediate data item definition 36 is used for the item definition of intermediate data used, for example, within a business flow definition corresponding to a logic flow diagram. The logic flow diagram represents business logic as a flow between business activities.

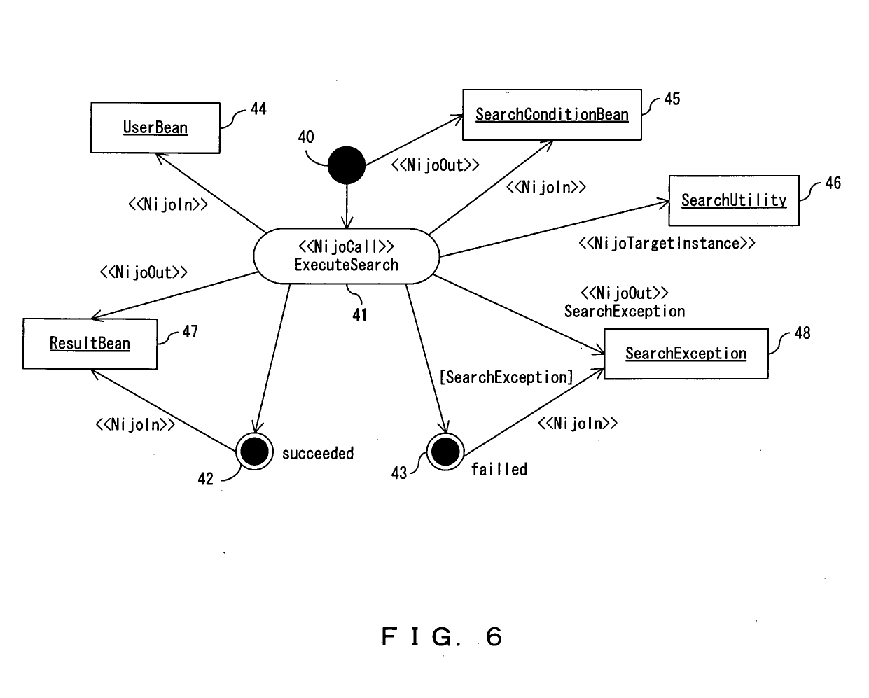

In this preferred embodiment, a new representation method different from a convention alone is used in a UML activity diagram as a representation example of the screen transition diagram 30 and the logic flow diagram 31, which are described with reference to FIG. 5, whereby the completely automatic generation of a program as a user interface application is enabled. A specific example of such an activity diagram is described with reference to FIG. 6.

In the UML activity diagram as the screen transition diagram 30, which is described with reference to FIG. 5, a diagram is described, for example, by alternately executing an activity which represents a screen, and an activity which represents a process (logic) normally between a start state (initial state) and an end state (final state), or by successively executing a plurality of processes.

FIG. 6 shows a simple example of the logic flow diagram. The logic flow diagram has a form where a logic flow between an initial state 40 and a final state, here two final states 42 and 43 is described. An ExecuteSearch activity 41 is called a Call activity, which is used to call another logic flow or another method including the outside of a model.

This preferred embodiment has one characteristic that in such a logic flow or screen transition diagram, an object which makes a data input/output to/from an activity can be designated, and an object to be called can be designated for a call activity. Notice that a name is assigned to each object as an identifier (ID), and a program is generated by interpreting this name as indicating the type of a class.

By way of example, arrows of stereotypes <<NijoIn>> and <<NijoOut>> indicate that input data from two objects UserBean 44 and SearchConditionBean 45 are given to the activity 41, and an output is given from the initial state 40 to the object SearchConditionBean 45. Additionally, an arrow of <<NijoTargetInstance>> designates that an object SearchUtility 46 is an object to be called.

For the final state 42, if a process corresponding to the call result of the object 46 is properly terminated, a return value to the call source of the logic flow shown in FIG. 6 is, for example, stored in an object ResultBean 47 and the return value becomes an input to the final state 42. In this preferred embodiment, the object 46 is, for example, defined not as an instantaneous state but as an object flow state accessed by a state such as the activity 41, etc.

If the process corresponding to the call result of the object 46 is improperly terminated, a guard (transition condition) of [SearchException] is applied. Then, an exception is stored in an object SearchException 48, a transition from the activity 41 to the final state 43 is made, and the exception becomes an input to the final state 43.

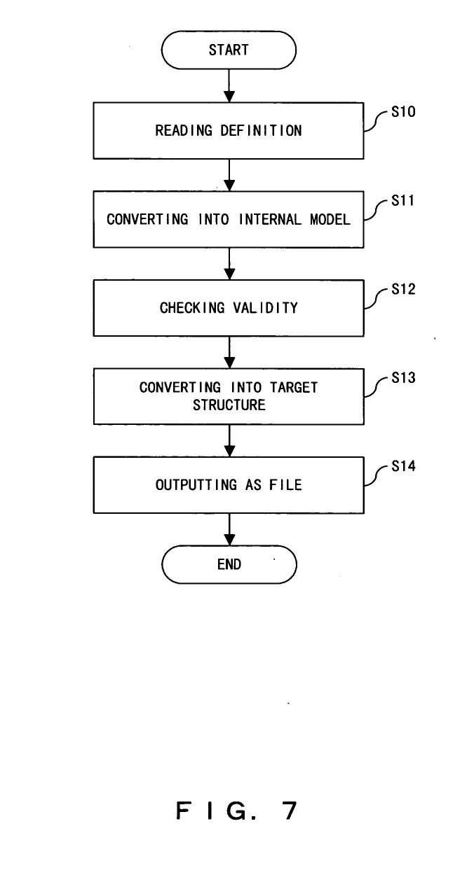

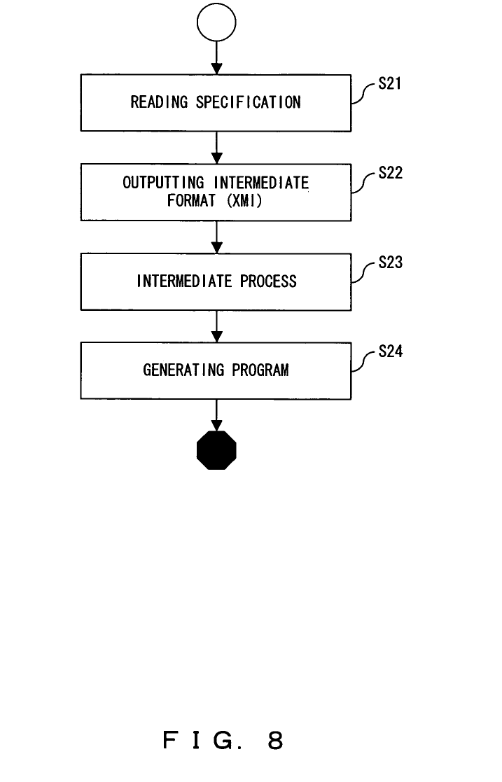

The basic flowchart of a program development process is described with reference to FIGS. 7 and 8 prior to the explanation of various new representation methods used for the completely automatic development of a user interface application in this preferred embodiment. FIG. 7 is a flowchart showing the whole of a process for generating an actual application program dependent on a platform in correspondence with FIG. 2.

Once the process is started in this figure, a definition (entity) in, for example, a text format is first read in step S10. In step S11, the definition entity is converted, for example, into an internal model in a UML, such as an object model in Java (registered trademark) language. In step S12, a validity check of determining whether or not the model is valid is made. Up to step S12, the process is not dependent on a platform.

Then, in step S13, the structure of the internal model is converted into a structure dependent on a target, namely, a platform. In step S14, a file as an application program, which is dependent on the platform and described with reference to FIG. 2, is output, and the process is terminated.

FIG. 8 is a flowchart showing a program automatic generation process whose steps S10 and S11 are especially emphasized among processes in steps S10 to S12 as the process which is shown in FIG. 7 and not dependent on a platform. Once the process is started in this figure, a specification that describes a definition entity such as a screen transition diagram, a logic flow diagram, etc., which are represented by a UML activity diagram, is read in step S21. In step S22, the specification is converted into an XML text format as an intermediate format by XMI (XML Metadata Interchange). For this conversion, a commercially available UML tool, or a free tool is available. The XMI, which is a standard format for data conversion between different CASE tools, can handle a UML extension portion, and converts data written in a specification into a text faithfully. Therefore, also with a representation newly defined in this preferred embodiment, the conversion into the intermediate format is executed without any problems.

Then, in step S23, an intermediate process is executed. In this intermediate process, the intermediate format file output in step S22 is read, the input/output relationship between an activity and an object, an object call relationship, etc., which are, for example, described with reference to FIG. 6, are interpreted, and a file as a program is generated based on the interpretation in step S24. Then, the process is terminated.

The intermediate process in step S23, and the program generation process in step S24, which are included in the flowchart shown in FIG. 8, are described below in correspondence with examples of the activity diagram for a specific example of the new representation method of a specification in this preferred embodiment.

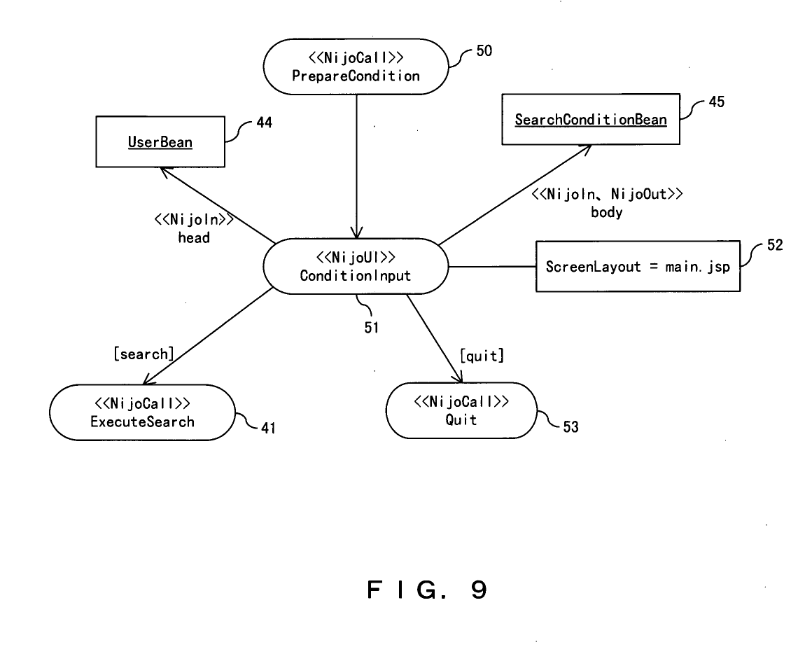

FIG. 9 partially shows an activity diagram, for example, as a screen transition diagram. This figure shows a transition from a Call activity named PrepareCondition 50, that is, an activity which represents a process to a screen display activity named ConditionInput 51, and a branch from the activity 51 to two activities ExecuteSearch 41 and Quit 53. Here, the activity 51 is, for example, an object which represents a JSP screen display. Here, such an activity is assumed to be called a UI (User Interface) activity. After the process of the activity 50 is terminated, a screen display is made in correspondence with the result of the process.

A dependent relationship exists between the activity 51 and the two objects 44 and 45. As explained with reference to FIG. 6, these two objects are represented as objects which indicate input data for a screen display for the UI object 51. At the same time, the object 45 is also represented as an object which indicates output data from the UI activity 51. Namely, data that a user inputs from the screen has the meaning of an output to the object 45 when viewed from the screen.

The branch from the UI activity 51 to the two activities 41 and 53 is determined, for example, depending on which of two buttons a user presses on the screen. [search] and [quit] as the guards (transition conditions) respectively attached to arrows to the activities 41 and 53 correspond to the button names on the screen, and the branch is decided depending on which of the two buttons the user presses.

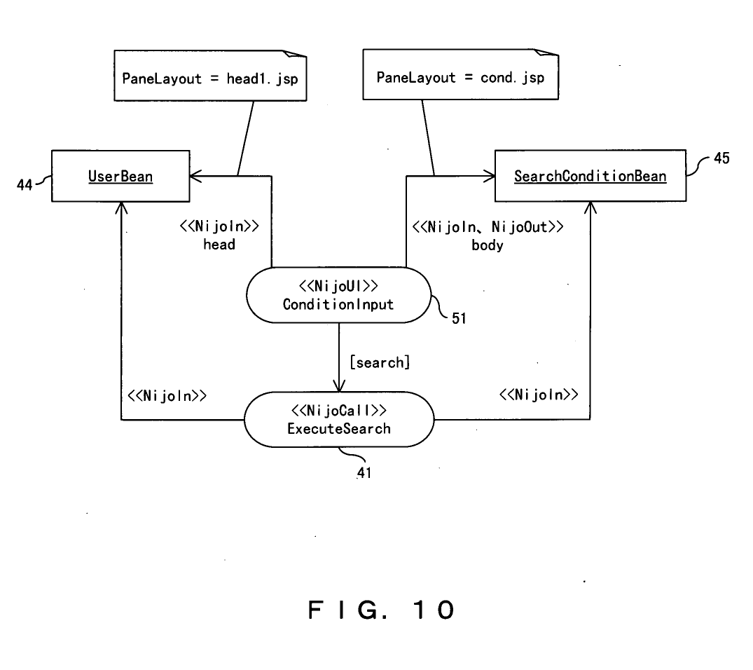

In FIG. 9, the UI activity 51 is associated with a property named ScreenLayout 52, and can represent a screen layout of JSP. FIG. 10 partially shows an activity diagram associated with this screen layout. ScreenLayout 52, which is shown in FIG. 9, describes that the screen is composed of two portions such as a head pane and a body pane as main.jsp, and desginates that the object 44 is displayed with a layout file named head1.jsp for the head pane, and the object 45 is displayed with a layout file named cond.jsp for the body pane when the UI activity 51 displays the UserBean object 44 and the SearchConditionBean object 45 in FIG. 10.

The intermediate process in step S23 of FIG. 8, and the program generation process in step S24 are described in correspondence with FIGS. 9 and 10.

In step S23, an intermediate format file (XMI) is read, and the following operations are performed.
(1) A JSP filename to be created (ConditionInput.jsp) is identified from the activity name ConditionInput.
(2) In XMI, layout information (main.jsp) associated to its pane name (head/body) by an ID, and a jsp file (head=head1.jsp/body=cond.jsp) linked to the pane are identified from a PaneLayout definition.
(3) An association made between each pane and an object used for the pane is identified.
(4) A button name is identified from action names [search] and [quit] of two lines drawn from ConditionInput.
(5) An association made between an object and its method is identified.

Files are created based on the above described information in step S24.
(1) To make the above described display, the files head1.jsp/cond.jsp/ConditionInput.jsp are created, and a link tag between the pane and the object used therein is embedded.
(2) Buttons and the object link tag are embedded in the above described files.
(3) A process method associated with the buttons is written to a table (this table corresponds to Servlet with the specification to read this table. If the correspondence between the process and the buttons is not made, a link which calls the method is directly embedded in the file).

(4) The process method program is written. Specifically, the above described operations (1) to (4) of step S24 becomes as follows.

ConditionInput.jsp:

omitted..
<include pane=“head”/>
<include pane=“body”/>
omitted..

head1.jsp:

omitted:
<jsp:useBean...id=head...class=“UserBean”/>
omitted..

cond.jsp:

omitted..
<jsp:useBean...id=body...class=“SearchConditio

nBean”/>

| | | |
|---|---|---|
| <input | value=“search” | type=“submit” |

name=“searchoo”/>

| | | |
|---|---|---|
| <input | value=“quit” | type=“submit” |

name=“quit××”/>

omitted..

table:

omitted..
SearchConditionBean; searchoo=ExecuteSearch.

sesarch_method

SearchConditionBean; quitxx=Quit.quit_method
omitted..

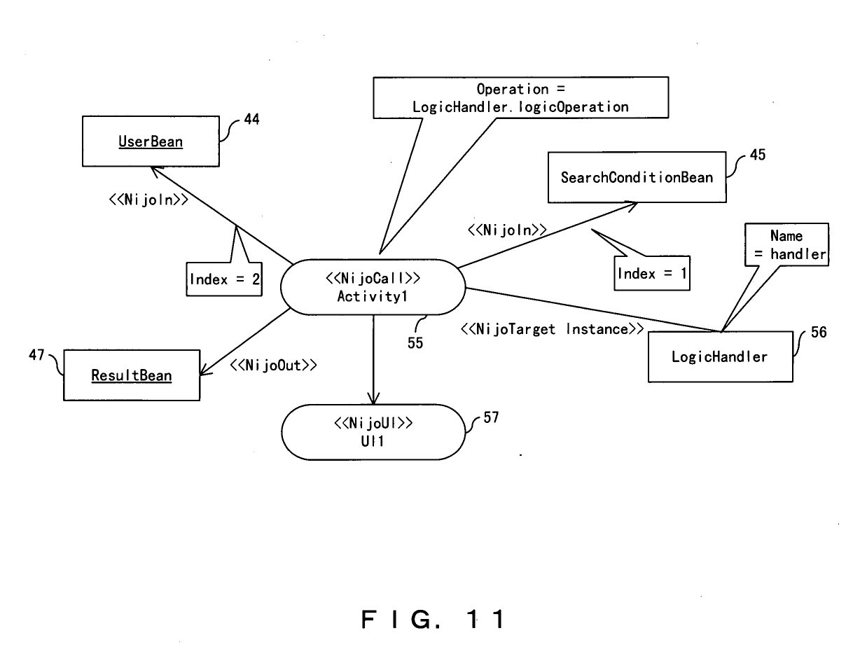

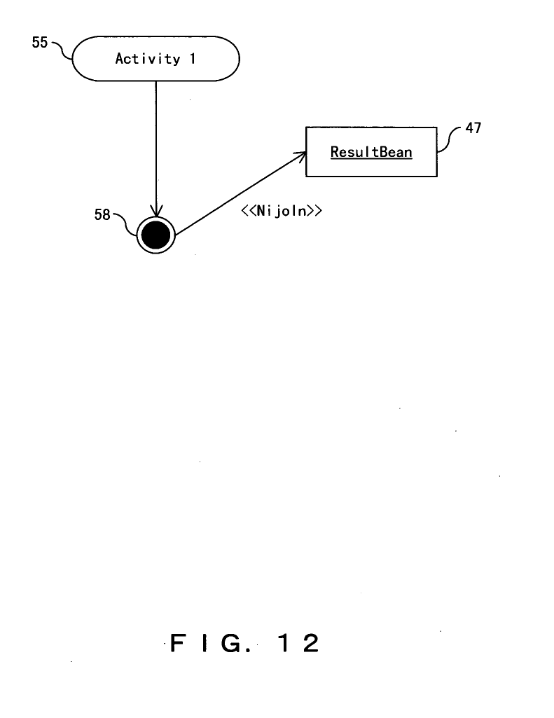

FIGS. 11 and 12 explain representation examples of the specifications of the call activity described with reference to FIG. 6. As described above, the call activity is called a Call activity. In FIG. 11, an Activity1 55 as the call activity has a dependent relationship with the two objects 44 and 45, and receives the input data from these objects. At that time, an order where the two input data are to be given as contents of a process, namely, the order of input parameters is designated as an index value. The index value is designated, whereby also the number of pieces of input data can be designated. In this way, this preferred embodiment is characterized in that an arrow is given to a segment which links an activity and an object, and a label and an order are given.

FIG. 11 indicates that the Call activity 55 calls a LogicHandler class 56 in a similar manner as in FIG. 6, and the name of its instance is handler. FIG. 11 also indicates that a logic operation method of the logic handler class, which is represented by a value having an operation tag of Activity1 is called.

In the intermediate process in step S23 of the flowchart shown in FIG. 8, an intermediate format file (XMI) is read, and the following operations are performed.
(1) It is identified that a target to be called by Activity1 is the LogicHandler class (its instance name is handler) indicated by <<NijoTargetInstance>>, and a logicOperation method of the LogicHandler class, which is represented by the value having the operation tag of Activity1 is called.
(2) In XMI, input/output information associated by an ID is searched, and identified including their order (index reading). In this example, it is identified that UserBean and SearchConditionBean are used in certain order as input parameters of the method of the above described class.
(3) It is identified that the object of a ResultBean class associated by <<NijoOut>> is output. In step S24, a file is created based on the above described information.

A call portion of the operation is created. Specifically, the call portion becomes as follows.
LogicHandler handler=new LogicHandler ( );
ResultBean res=handler.logicOperation (object of SearchConditionBean, object of UserBean)

A description method of a return value from a final state is described next. For example, if a partial activity diagram (module) which corresponds to a subroutine of a program exists among a plurality of activity diagrams, a return value from the partial activity diagram to its call source is required in correspondence with a final state. Its description method is explained with reference to FIGS. 12 to 15. FIG. 12 explains a representation method of a return value which accompanies a single final state. In this figure, a return value which accompanies a final state 58 becomes an object 47 as an input value, and the specification of the operation including this final state is described as follows.
ResultBean method name (argument);

If a dependent relationship does not exist between the final state 58 and the object 47 in FIG. 12, it is recognized that the return value does not exist. In that case, the specification of the operation including the final state 58 is described as follows.
void method name (argument)

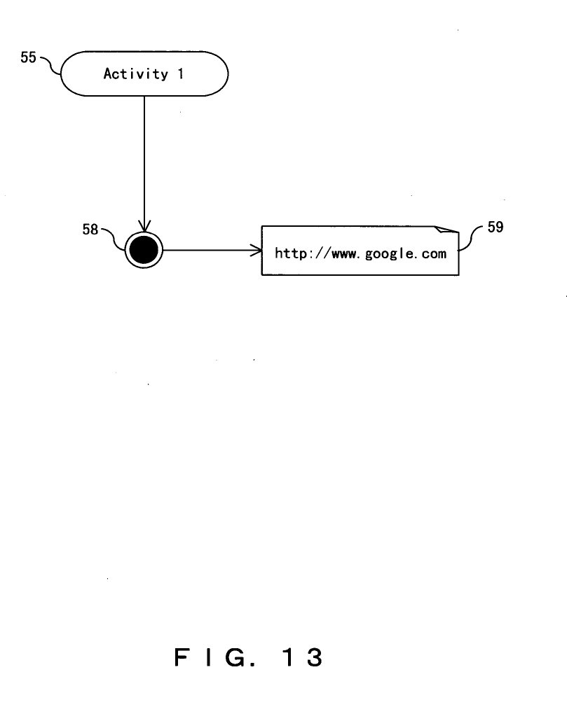

FIG. 13 shows an example where an expression, etc. is set in correspondence with a final state, and an action and a process, which correspond to the final state, are designated. In this figure, a URL 59 is set in correspondence with the final state 58, a move operation, for example, to a menu screen designated by this URL can be set from the end state 58.

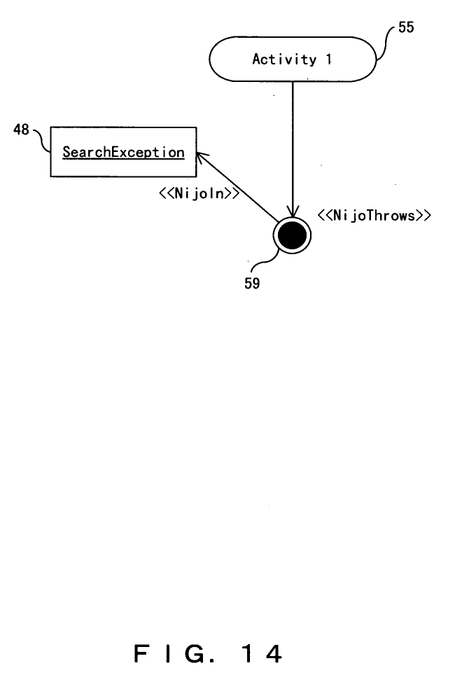

FIG. 14 explains a description example of a return value which accompanies the final state of an exception. In the example shown in this figure, the specification of an operation including the final state 59 becomes the following format by describing SearchException in a throws phrase.
return value method name (argument) throwsSearchException;

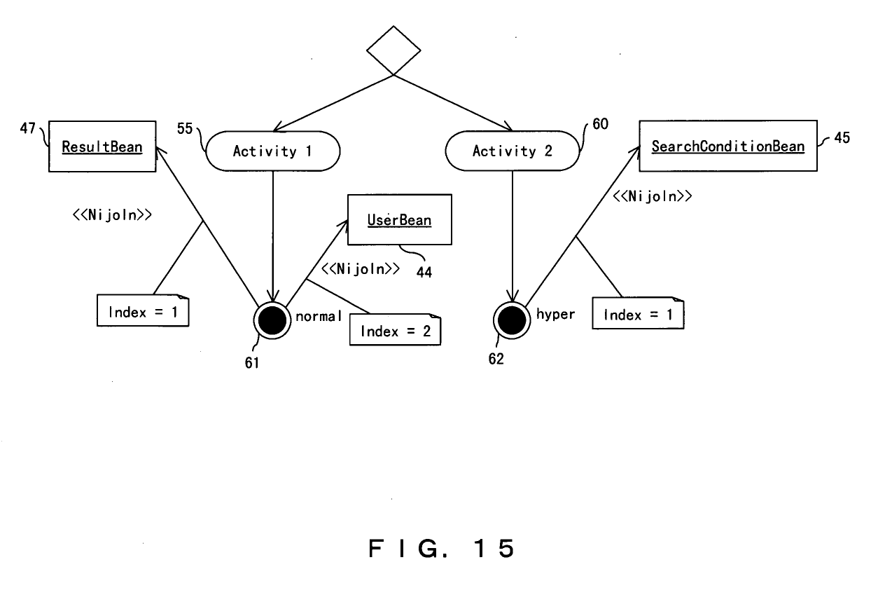

FIG. 15 exemplifies an activity diagram including a plurality of final states. In this figure, two objects 44 and 47 become return values from a final state “normal” 61 to which a transition is made from the Activity1 55, and a return value from a final state hyper 62 to which a transition is made from an Activity2 60 becomes an object 45. For the return values from the final state 61, its order is designated by an index value. An index for the return value from the final state 62 can be omitted. A diamond at the top of the figure represents a conditional branch. The specification of the operation including this final state is descried as follows.
NijoResultSet method name (argument);

In step S23 of the flowchart shown in FIG. 8, an intermediate format file (XMI) is read, and the following operations are performed.
(1) The operation including this final state is searched, and its method name is identified.
(2) If input data linked from this final state does not exist, void is identified as a return value. If the number of pieces of input data is 1, a linked object name is identified as a return value. In the case of an exception, a throws phrase is identified as a return value. If a plurality of final states are included, a class named NijoResult which includes all of the end states is created, and the names of the respective states, links of return values, and the order of objects of the return values are held as its attributes.
(3) Whether or not an expression (URL) is linked is searched, and identified.

In step S24, a file is created based on the above described information.
(1) When the signature of the operation is created, the signature of a method according to each case is written.
(2) In the case of NijoResult, a return value is used as the attribute of that class, and a Set/Get method is created according to the name of an end state.
   NijoResult res=new NijoResult ( );
   res.set (normal, 1, ResultBean);
   res.set (normal, 2, UserBean);
   res.set (hyper, 1, SearchConditionBean);
   . . . .
(3) If the expression is linked, contents of the expression is written as the next operation.

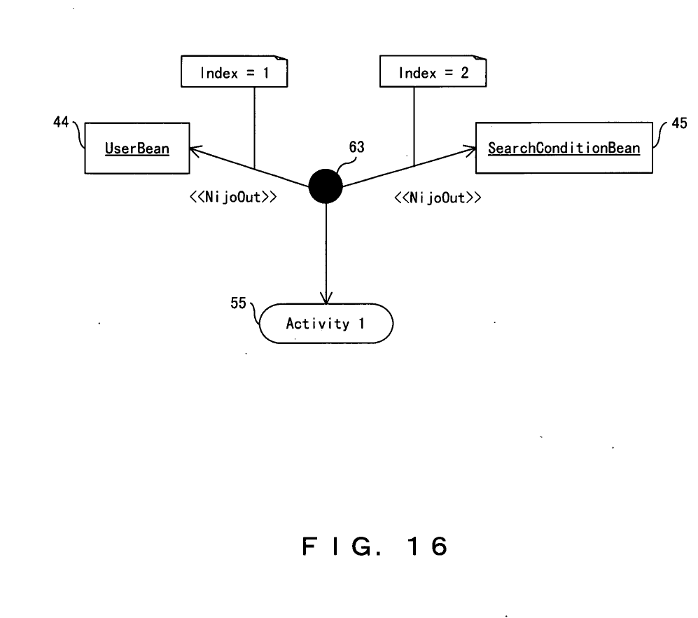

FIG. 16 explains a representation method of an input/output object which accompanies an initial state. In this figure, a transition is made from an initial state 63 to the activity 55. At the same time, the initial state 63 outputs the two objects 44 and 45, and the specification of this operation becomes as follows.
return value operation name (UserBean, SearchConditionBean);

In step S23 of the flowchart shown in FIG. 8, an intermediate format file (XMI) is read, and the following operations are performed.
(1) The operation including this initial state is searched, and its method name is identified.
(2) If output data linked from the initial state does not exist, the output data is identified as not existent. If the link exists, the XMI file is searched and each piece of output data is identified based on an index order. In the example shown in FIG. 16, UserBean and SearchConditionBean are respectively identified as the first and the second parameters.

In step S24, a file is created based on the above described information. Namely, a parameter name is written when the signature for the operation is created.

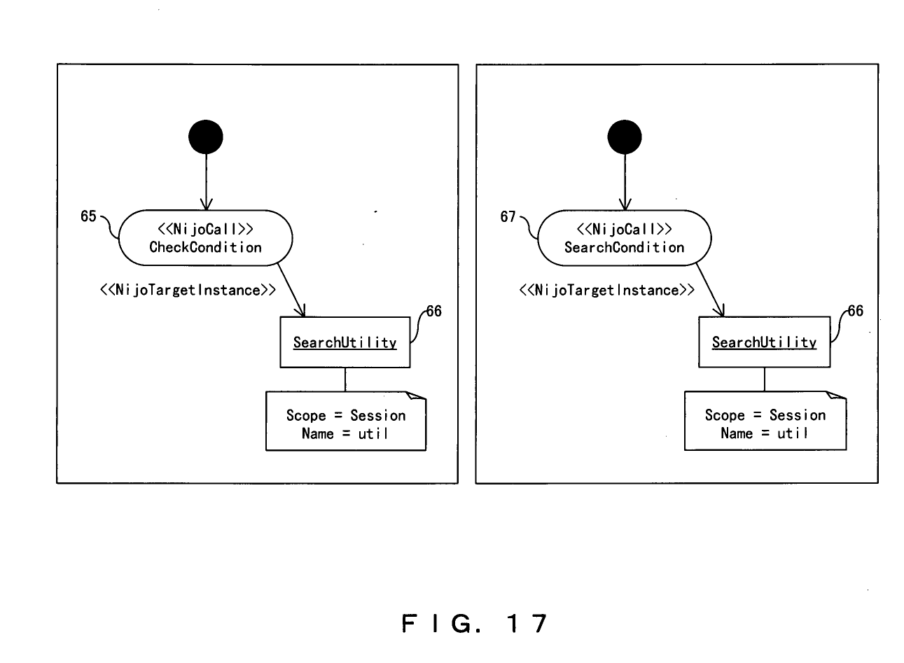

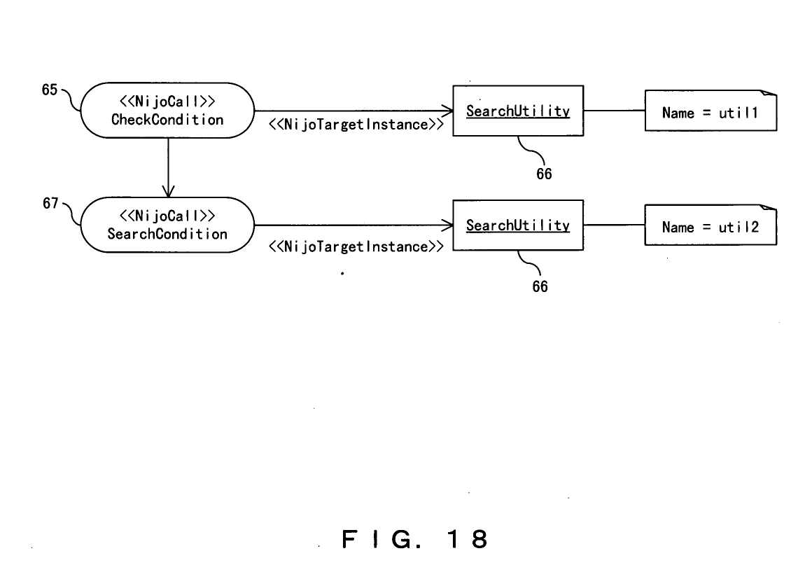

A description method of the life cycle specification of an activity instance is described next with reference to FIGS. 17 and 18. Generally, in a plurality of screen transition activity diagrams, the scope and the identifier such as the name, of an object are designated, so that an operation for the same instances or different instances generated from the object can be represented. In FIG. 17, a CheckCondition activity 65 and a SearchCondition activity 67 designate the same SearchUtility object flow state 66 respectively in screen transition diagrams on the left and the right sides. Since the scopes and the names of these objects are respectively designated to be Session and the same in their instances, the instances of the two objects 66 are designated to be the same.

For a scope which indicates the lifetime of an object, 5 types of distinction can be implemented. These types are assumed to include Local that is valid only for a page corresponding to a current flow, Request that is valid until a reply is returned to a request from a client, Session that is managed on a server side and makes an object alive even if a screen is changed, Application that is valid during a current application, and System that is valid in the whole of the system.

FIG. 18 shows a description example of a method designating different instances. This figure shows that activities 65 and 67 respectively designate the same class 66, but the names of the instances are different.

The process of the flowchart shown in FIG. 8 is described in correspondence with FIGS. 17 and 18. In step S23, an intermediate format file (XMI) is read, and the following operations are performed.
(1) In FIG. 18, NijoTargetInstance information linked to CheckCondition is searched, and the class is identified as a SearchUtility class from the name of the information. Additionally, its Scope and object name are respectively identified as Session and utility 1 as associated information.
(2) NijoTargetInstance information linked to SearchCondition is searched, and the class is identified as a SearchUtility class from the name of the information. Its scope and object name are respectively identified as Session and util 2 as associated information.
(3) If the names and Scopes of the objects match as shown in FIG. 17, the same instance is identified as being called, and the same object instance as that used by CheckCondition is made usable by SearchCondition.
(4) If Scopes or the names are different, the instances are different. Therefore, separate objects are generated and used.

In step S24, a file is created based on the above described information.

Based on the above identification items, the program is generated to enable the object to be passed if the same instance is called. Actually, an object for each session is created outside a method, and managed in an object table. Therefore, an object may be referenced according to its name when used in a method.

An example where instances are different is specifically shown below.
method of a SearchUtility.java class called from CheckCondition.
call target=session object table get (util 1);
call target=check ( . . . );
method of a SearchUtility.java class called from SearchCondition
call target=session object table get (util 2);
call target=search ( . . . );

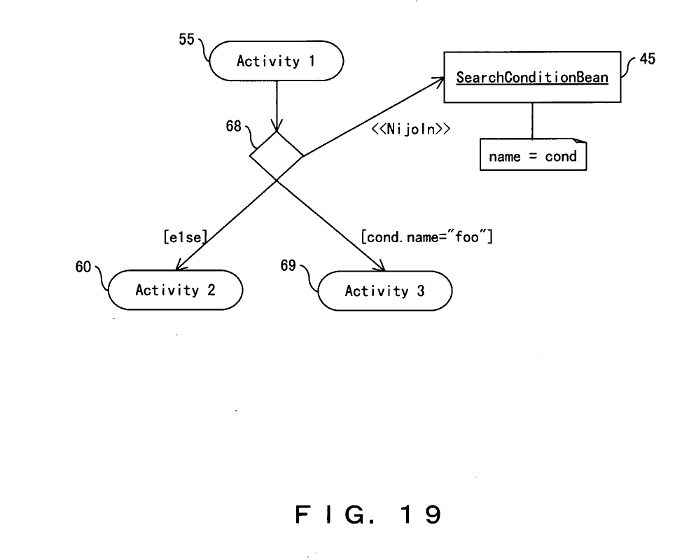

FIG. 19 explains a description method of parameter designation as a condition for a conditional branch. As described with reference to FIG. 15, the conditional branch is represented as a diamond in an activity diagram. Conventionally, a parameter, which becomes a target of conditional determination, cannot be designated although a condition itself can be described. Here, an object having a dependent relationship is defined as an input parameter for the conditional determination, so that a conditional determination parameter can be represented. Namely, in FIG. 19, the branch is made based on the value of the object 45 which has a dependent relationship with a conditional branch 68, and gives an input. The branch is made to the activity 69 if the name property of the object 45 is “foo”, or to the activity 60 if the name property is not “foo”.

In step S23 of the flowchart shown in FIG. 8, an intermediate format file (XMI) is read, and the following operations are performed.
(1) A branch and input data SearchConditionBean, which is associated with the branch, are searched and identified.
(2) Since the instance of the SearchConditionBean class is represented as cond, destination activities of conditional statements [cond.name=“foo”] and [else] from the branch are identified.

If cond.name=“foo” is included in the condition of the if statement, and if the statement is true, the branch is made to the Activity3. If the statement is false, the branch is made to the Activity2.

In step S24, a file is created based on the above described information.

A program which reflects the above described specification is written. Specifically, the program becomes as follows.

if (cond.name=“foo”)
target class of Activity3. method name ( );

else

target class of Activity2. method name ( );

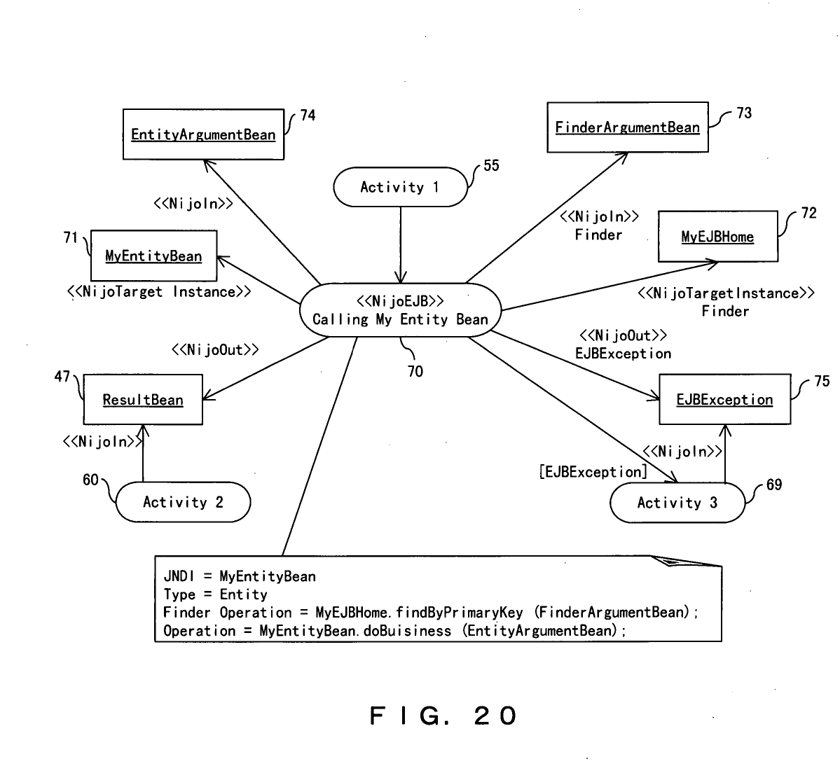

Lastly, a description method of call specification of a distributed object component is described with reference to FIG. 20. Here, a description is provided by considering an EJB (Enterprise Java Beans) component, which is technical specifications of server side Java, as a representative application of the distributed object component, and by taking EntityBean as an example. By calling such a distributed component typified by EJB in an activity diagram, for example, a disadvantage in the case where an exchange is written in a flowchart, etc., namely, a disadvantage that a request and a response occur many times in an actual operation, and they must be described for each occurrence can be avoided. Since a process in such a distributed component is a standard process, it is easy to build a code to be written by a user if only configuration information exists. This EJB activity is a representative as an example which represents information handled by such a standard process.

In step S23 of the flowchart shown in FIG. 8, an intermediate format file (XMI) is read, and the following operations are performed.
(1) The stereotype of a CallingMyEntityBean activity is identified as NijoEJB, and information for calling an EJB component is searched.
(2) Since Finder is not attached to <<NijoTargetInstance>>, MyEntityBean is proved to be a class to be called.
(3) Since EntityArgumentBean which is not designated in Finder is <<NijoIN>>, it is identified as becoming a parameter of doBusiness.
(4) It is identified from a value having a tag of CallingMyEntityBean that a JNDI name is MyEntityBean, the type of the EJB is not Session but Entity, FinderOperation is MyEJBHome.findByPrimaryKey, and call Operation is a doBusiness method of the MyEntityBean class.
(5) The input object designated in Finder is identified as the same Finder parameter of the FinderArgumentBeanHome object similar to the Home object designated in <<NijoTargetInstance>>Finder.
(6) <<NijoOut>> has ResultBean, which becomes an output object. Since an EJBException label is affixed to another <<NijoOut>>, it is proved to be an Exception class output in the case of an exception. In the case of an exception, this object is output and a transition is made to Activity3. In a normal case, a transition is made to Activity2.

In step S24, a file is created based on the above described information. In this example, code having the following contents is generated.
1. Since the value having the JNDI tag is designated, a MyEJBHome object is obtained by using MyEntityBean as a key. An object obtained as a result of the call is stored in an object indicated by MyEJBHome object flow state.
2. A findByPrimaryKey method of MyEJBHome is called. At that time, an object indicated by a FinderArgumentBean object flow state is set as an argument. The object obtained as a result of the call is stored in the object indicated by a MyEntityBean object flow state.
3. A doBusiness method is called for the above obtained MyEntityBean. As an argument, the object indicated by an EntityArgument Bean object flow state is used. The result is stored in ResultBean. In the case of an exception, the result is stored in EJBException.

As described above, the preferred embodiment according to the present invention is explained by taking as an example an activity diagram such as a UML screen transition diagram, logic flow diagram, etc. However, the automatic generation of a program as a target to which the present invention is applied is not limited to the UML, as a matter of course.

The present invention is available to all industries that require the development of an application program having a user interface, such as a Web program, etc., for example, to a software development industry that provides such a program to a business dealer for a user, etc.

1. A user interface application development program for causing a computer to execute a process for automatically generating a user interface application program, the process comprising:
reading a specification data for application development, which corresponds to a screen transition diagram where a screen and a process are described, and can make an association between a screen and/or a process and an object as input/output data; and
automatically interpreting the read specification data including the association made between the screen and/or the process and the object, and generating the user interface application program.

2. The user interface application development program according to claim 1, wherein
the object is an object which corresponds to a screen display process, and the specification data further indicates a screen layout in addition to the association made between the process and a data input/output object for a screen to be displayed.

3. The user interface application development program according to claim 1, wherein
the object corresponds to a process which is associated with a screen transition and intended to call an external process, and the specification data indicates an order of each plurality of input objects or output objects for the associated process in the association.

4. The user interface application development program according to claim 1, wherein
the specification data can further enable a user to designate a next state transition condition on a displayed screen.

5. The user interface application development program according to claim 1, wherein
the specification data can further define an identifier of a final state, a type of a state including an exception, an expression describing an action at a time of an end, one or more return values to a call source of a screen transition diagram, a data input/output object corresponding to the final state, and an order of inputs/outputs in correspondence with one or more final states in the screen transition diagram, and can control the final state including a call relationship among a plurality of screen transition diagrams.

6. The user interface application development program according to claim 1, wherein
the specification data can further define a data input/output object corresponding to an initial state, and an order of inputs/outputs in correspondence with the initial state in the screen transition diagram, and can control the initial state including a call relationship among a plurality of screen transition diagrams.

7. The user interface application development program according to claim 1, wherein
the specification data can further determine whether or not a plurality of instances of objects having a same name are identical in a plurality of screen transition diagrams by designating Scopes for the instances.

8. The user interface application development program according to claim 1, wherein
the specification data can further designate a parameter input object which indicates a condition of a branch in correspondence with a branch process within the screen transition diagram.

9. The user interface application development program according to claim 1, wherein
the specifications data further includes data which enables a call of a distributed object component based on a protocol of the distributed object component.

10. A user interface application development apparatus, comprising:
a specification data reading unit reading a specification data for application development, which corresponds to a screen transition diagram where a screen and a process are described, and can make an association between a screen and/or a process and an object as input/output data; and
a program generating unit automatically interpreting the read specification data including the association made between the screen and/or the process and the object, and generating a user interface application program.
